(19) United States
(12) Patent Application Publication
(10) Pub. No.: US 2015/0302472 A1
(43) Pub. Date: Oct. 22, 2015

(54) METHOD AND APPARATUS FOR PRESENTING TARGETING CONDITION OF NETWORK ADVERTISEMENT

(71) Applicant: TENCENT TECHNOLOGY (SHENZHEN) COMPANY LIMITED, Shenzhen, Guangdong (CN)

(72) Inventors: Yanqi ZHANG, Shenzhen (CN); Yan ZHAO, Shenzhen (CN); Yingyi JIANG, Shenzhen (CN)

(21) Appl. No.: 14/646,294

(22) PCT Filed: Oct. 23, 2013
(86) PCT No.: PCT/CN2013/085777

§ 371 Date: May 20, 2015

(30) Foreign Application Priority Data
Nov. 23, 2012 (CN) 201210483077,X

(51) Int. Cl. G06Q 30/02

(52) U.S. Cl. CPC G06Q 30/0254

(57) ABSTRACT

The present disclosure relates to the field of network technologies. Disclosed are a method and an apparatus for presenting a targeting condition of a network advertisement. The method includes: acquiring information about delivery click-through situations, of a historical advertisement having a type the same as a type of a to-be-delivered advertisement, in targeting conditions; determining a targeting condition matching the historical advertisement among the targeting conditions according to the acquired information about the delivery click-through situations; and presenting the determined targeting condition. The present disclosure can improve the utilization rate of system and network resources in a network advertisement delivery process.

### RELATED APPLICATION

This application is a U.S. National Phase Application under 35 U.S.C. 371 of International Application No. PCT/CN2013/085777 filed on Oct. 23, 2013 and published in Chinese as WO 2014/079297 A1 on May 30, 2013. This application claims priority to Chinese Patent Application No. 201210483077X, filed with the Chinese Patent Office on Nov. 23, 2012 and entitled “METHOD AND APPARATUS FOR PRESENTING TARGETING CONDITION OF NETWORK ADVERTISEMENT”. The entire disclosures of the above applications are incorporated herein by reference in their entirety.

### FIELD OF THE TECHNOLOGY

The present disclosure relates to the field of network technologies, and in particular, to a method and an apparatus for presenting a targeting condition of a network advertisement.

### BACKGROUND OF THE DISCLOSURE

With the development of network technologies, Internet has gradually become an indispensable part of life of more people. A network advertisement also grows as the Internet evolves. The network advertisement occupies a bigger share among all kinds of advertising due to its flexibility and diversity.

Targeting of a network advertisement (hereinafter briefly referred to as advertisement) refers to selecting, when an advertisement is to be delivered, a user group to which the advertisement is delivered. The user group is selected according to a targeting condition. During targeted delivery of a network advertisement, a targeting condition, such as, gender, age, and geography, may be selected, and the advertisement is delivered to a user group that meets the targeting condition. Therefore, only a user group that meets the targeting condition may see the advertisement. During delivery of a network advertisement, selecting a proper targeting condition can increase a click-through rate of the advertisement to a relatively high expected level, where the targeting condition is a targeting condition matching the advertisement. During delivery of a new advertisement, an advertisement delivery platform cannot recommend a targeting condition matching the new advertisement to an advertisement deliverer, as a result, the advertisement deliverer selects a targeting condition blindly and a matching degree of the selected targeting condition is relatively low, which leads to a low click-through rate of the advertisement, thereby greatly reducing the utilization rate of system and network resources, and causing waste of resources.

### SUMMARY

Embodiments of the present invention provide a method and an apparatus for presenting a targeting condition of a network advertisement, so as to improve the utilization rate of system and network resources in a network advertisement delivery process. The technical solutions are as follows:

According to one aspect, a method for presenting a targeting condition of a network advertisement is provided, including:

acquiring information about delivery click-through situations, of a historical advertisement having a type the same as a type of a to-be-delivered advertisement, in targeting conditions;

determining a targeting condition matching the historical advertisement among the targeting conditions according to the acquired information about the delivery click-through situations; and

presenting the determined targeting condition,

in which, the acquiring information about delivery click-through situations, of a historical advertisement having a type the same as a type of a to-be-delivered advertisement, in targeting conditions is specifically:

searching for a historical advertisement that has a type and an advertisement deliverer the same as the type and an advertisement deliverer of a to-be-delivered advertisement and is delivered in a preset time period; and searching for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and

acquiring information about click-through situations of the found historical advertisement in targeting conditions.

If the to-be-delivered advertisement is not a newly delivered advertisement, the method further includes:
searching for a historical advertisement in previous delivery of the to-be-delivered advertisement delivered in a preset time period; and
if the historical advertisement is not found, the searching for a historical advertisement that has a type and an advertisement deliverer the same as the type and an advertisement deliverer of the to-be-delivered advertisement and is delivered in the preset time period; and searching for, if the historical advertisement is not found, a historical advertisement that has a type the same as a type of the to-be-delivered advertisement but has an advertisement deliverer different from the advertisement deliverer of the to-be-delivered advertisement and is delivered in the preset time period is performed.

Preferably, there is one historical advertisement and the information about the delivery click-through situations includes click-through rates; and

the determining a targeting condition matching the historical advertisement among the targeting conditions according to the acquired information about the delivery click-through situations is specifically:

determining, according to the click-through rates of the historical advertisement in the targeting conditions, a targeting condition having a corresponding click-through rate greater than a preset threshold as a targeting condition matching the historical advertisement.

Preferably, there are more than one historical advertisements, and the information about the delivery click-through situations includes delivery amounts and click-through amounts; and

the determining a targeting condition matching the historical advertisement among the targeting conditions according to the acquired information about the delivery click-through situations is specifically:

determining, for each targeting condition, an average click-through rate of the historical advertisements in the targeting condition according to delivery amounts and click-through amounts of the historical advertisements in the targeting condition; and

determining a targeting condition having a corresponding average click-through rate greater than a preset threshold as the targeting condition matching the historical advertisements.

Preferably, the preset threshold is a sum of a total click-through rate of an advertisement delivery platform and a preset percentage value.

Preferably, the presenting the determined targeting condition is specifically:

presenting the determined targeting condition in correspondence to the click-through rate or average click-through rate of the historical advertisement in the targeting condition.

Preferably, the method further includes: delivering the to-be-delivered advertisement according to the determined targeting condition.

According to another aspect, an apparatus for presenting a targeting condition of a network advertisement is provided, including:

an acquisition module, configured to acquire information about delivery click-through situations, of a historical advertisement having a type the same as a type of a to-be-delivered advertisement, in targeting conditions;

a determining module, configured to determine a targeting condition matching the historical advertisement among the targeting conditions according to the acquired information about the delivery click-through situations; and

a presentation module, configured to present the determined targeting condition,

in which, the acquisition module is specifically configured to:

search for a historical advertisement that has a type and an advertisement deliverer the same as the type and an advertisement deliverer of a to-be-delivered advertisement and is delivered in a preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and

acquire information about click-through situations of the found historical advertisement in targeting conditions.

If the to-be-delivered advertisement is not a newly delivered advertisement, the acquisition module is further configured to:
search for a historical advertisement in previous delivery of the to-be-delivered advertisement delivered in a preset time period;

if the historical advertisement is not found, the acquisition module is configured to search for a historical advertisement that has a type and an advertisement deliverer the same as the type and an advertisement deliverer of the to-be-delivered advertisement and is delivered in the preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period.

Preferably, there is one historical advertisement and the information about the delivery click-through situations includes click-through rates; and

the determining module is specifically configured to:

determine, according to the click-through rates of the historical advertisement in the targeting conditions, a targeting condition having a corresponding click-through rate greater than a preset threshold as a targeting condition matching the historical advertisement.

Preferably, there are more than one historical advertisements, and the information about the delivery click-through situations includes delivery amounts and click-through amounts; and

the determining module is specifically configured to:

determine, for each targeting condition, an average click-through rate of the historical advertisements in the targeting condition according to delivery amounts and click-through amounts of the historical advertisements in the targeting condition; and

determine a targeting condition having a corresponding average click-through rate greater than a preset threshold as a targeting condition matching the historical advertisements.

Preferably, the preset threshold is a sum of a total click-through rate of an advertisement delivery platform and a preset percentage value.

Preferably, the presentation module is specifically configured to:

present the determined targeting condition in correspondence to the click-through rate or average click-through rate of the historical advertisement in the targeting condition.

Preferably, the apparatus further includes:
a delivery module, configured to deliver the to-be-delivered advertisement according to the determined targeting condition.

The beneficial effects brought by the technical solutions provided in the embodiments of the present invention are as follows:

According to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for presenting a targeting condition of a network advertisement according to Embodiment 1 of the present invention;

FIG. 2 is a flowchart of a method for presenting a targeting condition of a network advertisement according to Embodiment 3 of the present invention;

FIG. 3 is a flowchart of a method for presenting a targeting condition of a network advertisement according to Embodiment 4 of the present invention;

FIG. 4 is a schematic structural diagram of an apparatus for presenting a targeting condition of a network advertisement according to Embodiment 5 of the present invention; and

FIG. 5 is a schematic structural diagram of a server in an embodiment of the present invention.

### DESCRIPTION OF EMBODIMENTS

To make the objectives, technical solutions, and advantages of the present disclosure more clearly, the following further describes the implementation manners of the present disclosure in detail with reference to the accompanying drawings.

### Embodiment 1

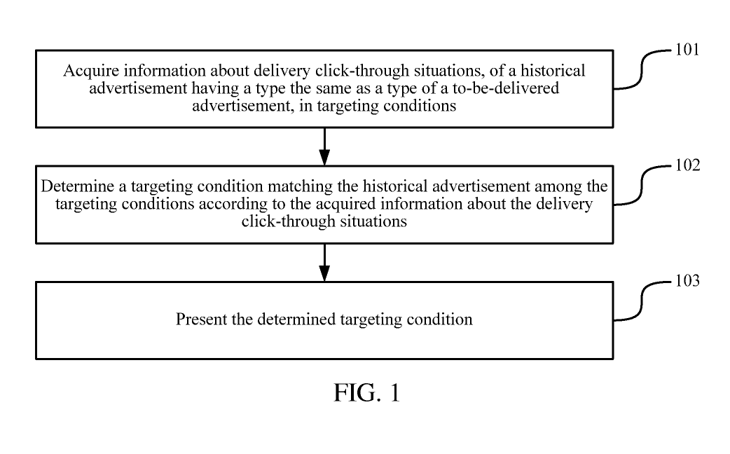

This embodiment of the present invention provides a method for presenting a targeting condition of a network advertisement. Referring to FIG. 1, the process of the method may include the following steps:

Step 101: Acquire information about delivery click-through situations, of a historical advertisement having a type the same as a type of a to-be-delivered advertisement, in targeting conditions.

Step 102: Determine a targeting condition matching the historical advertisement among the targeting conditions according to the acquired information about the delivery click-through situations.

Step 103: Present the determined targeting condition.

In this embodiment of the present invention, according to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

### Embodiment 2

This embodiment of the present invention provides a method for presenting a targeting condition of a network advertisement. The method may be preferably executed by an advertisement delivery platform. In this embodiment, a network advertisement may specifically be a social advertisement. The social advertisement is a network advertisement delivered on the basis of a social network platform, and an advertisement delivery platform of the social advertisement is established on the basis of the social network platform. In an advertisement delivery process, the social advertisement may be delivered targetedly by using user file information in the social network platform. The social advertisement may also include a common external-link advertisement (an advertisement of a commodity, a service, or the like in another platform except the social network platform), an application advertisement (an advertisement of an application in the social network platform), and the like. The following describes a process shown in FIG. 1 in detail with reference to the specific processing method. The specific content is as follows.

Step 101: An advertisement delivery platform acquires information about delivery click-through situations, of a historical advertisement having a type the same as a type of a to-be-delivered advertisement, in targeting conditions.

A type of an advertisement may be grouped according to attribute information of the advertisement, for example, the advertisement is classified according to a type of a target commodity in the advertisement, where the advertisement, for example, is a clothing advertisement, a refrigerator advertisement, a dining-table advertisement, or the like, or the advertisement is classified according to a presentation form of the advertisement. The historical advertisement is a previously-delivered advertisement. A database may be established in the advertisement delivery platform for storing a delivered advertisement and related information. Specifically, the database may store an identifier of the historical advertisement, content information (which may include a text, a link, a picture, a video, and the like) of the historical advertisement, information about a delivery click-through situation of the historical advertisement, and the like. The information about the delivery click-through situation of the advertisement may include one or more pieces of the following: a delivery amount, a click-through amount, a click-through rate, a targeting condition selected during delivery, and a delivery amount, a click-through amount, and a click-through rate in each targeting condition, and the like.

In this step, a historical advertisement meeting a condition may be selected first, and then stored information related to the historical advertisement may be acquired. There is one or more selected historical advertisements. The selected historical advertisement may be all or some of historical advertisements meeting a condition. The targeting conditions described herein may be a union set of targeting conditions selected during delivery of selected historical advertisements, or may also be a part of selected targeting conditions.

Specifically, the acquiring information about delivery click-through situations, of a historical advertisement having a type the same as a type of a to-be-delivered advertisement, in targeting conditions may be performed according to the following methods:

### Method 1

This method may be used in a delivery process of a new advertisement, or may also be used in redelivery process of an advertisement that has been delivered. Preferably, the method is used in a delivery of the new advertisement (that is, a to-be-delivered advertisement is a newly delivered advertisement).

First, a historical advertisement that has a type and an advertisement deliverer the same as a type and an advertisement deliverer of a to-be-delivered advertisement and is delivered in a preset time period is searched for, and if the historical advertisement is not found, a historical advertisement that has a type the same as a type of the to-be-delivered advertisement but has an advertisement deliverer different from the advertisement deliverer of the to-be-delivered advertisement and is delivered in the preset time period is searched for; then, information about click-through situations of the found historical advertisement in targeting conditions is acquired. The preset time period may be a preset period of time before a current moment, for example, a week ago, three days ago, or the like. Setting of the time period can better improve a matching degree (a higher click-through rate indicates a higher matching degree of a corresponding targeting condition) of a finally recommended targeting condition.

An idea of the method is: searching a historical advertisement delivered by an advertisement deliverer (or referred to as an advertiser) of a to-be-delivered advertisement for a historical advertisement having a same type in a preset time period, and if the historical advertisement can be found, acquiring information about click-through situations of the found historical advertisement in targeting conditions, or if the historical advertisement is not found, continuing to search the entire advertisement delivery platform for a historical advertisement having the same type in the preset time period, and acquire information about click-through situations of the found historical advertisement in targeting conditions. If another advertiser does not deliver a historical advertisement having a same type in the preset time period either, no targeting condition may be recommended to the advertiser of the to-be-delivered advertisement for the moment. In this method, priority is given to a search for a historical advertisement of a same advertiser, and if there is no such a historical advertisement, a historical advertisement of another advertiser is then searched for, which can better improve a matching degree of a finally recommended targeting condition.

For example, the advertiser of the to-be-delivered advertisement delivers, within a week, two advertisements having types the same as the type of the to-be-delivered advertisement, and then, information about click-through situations of the two historical advertisements in targeting conditions may be acquired. For another example, the advertiser of the to-be-delivered advertisement does not deliver, within a week, an advertisement having a type the same as a type of the to-be-delivered advertisement, but another advertiser delivers, within a week, five advertisements having types the same as the type of the to-be-delivered advertisement, information about click-through situations of the five historical advertisements in targeting conditions may be acquired.

### Method 2

This method may be used in redelivery process of an advertisement that has been delivered (that is, a to-be-delivered advertisement is a newly delivered advertisement).

First, a historical advertisement in a previous delivery of the to-be-delivered advertisement delivered in a preset time period is searched for; if the historical advertisement is not found, a historical advertisement that has a type and an advertisement deliverer the same as the type and an advertisement deliverer of the to-be-delivered advertisement and is delivered in a preset time period is searched for; and if the historical advertisement is not found, a historical advertisement that has a type the same as a type of the to-be-delivered advertisement but has an advertisement deliverer different from the advertisement deliverer of the to-be-delivered advertisement and is delivered in the preset time period is searched for; then, information about click-through situations of the found historical advertisement in targeting conditions is acquired. The preset time period may be a preset period of time before a current moment, for example, a week ago, three days ago, or the like.

A network advertisement may be delivered many times. If a to-be-delivered advertisement is an advertisement that has already been delivered and is to be delivered again, an advertisement that was delivered previously and corresponds to the to-be-delivered advertisement is a historical advertisement corresponding to the to-be-delivered advertisement. Content information of the to-be-delivered advertisement is the same as that of the historical advertisement.

An idea of the method is: first determining, by searching a historical delivery record of the to-be-delivered advertisement, whether a to-be-delivered advertisement is delivered in a preset time period; and if a historical advertisement is found, acquiring information about click-through situations of the found historical advertisement in targeting conditions; or if a historical advertisement is not found, continuing to search a historical advertisement delivered by an advertiser of the to-be-delivered advertisement for a historical advertisement having a same type in a preset time period, and if the historical advertisement can be found, acquiring information about click-through situations of the found historical advertisement in targeting conditions, or if the historical advertisement is not found, continuing to search the entire advertisement delivery platform for a historical advertisement having a same type in a preset time period, and acquire information about click-through situations of the found historical advertisement in targeting conditions. If another advertiser does not deliver a historical advertisement having a same type in the preset time period either, no targeting condition may be recommended to the advertiser of the to-be-delivered advertisement for the moment. A historical delivery of the to-be-delivered advertisement is searched for first, then a historical advertisement of a same advertiser is searched for, and last, a historical advertisement of another advertiser is searched for, which can better improve a matching degree of a finally recommended targeting condition.

Step 102: The advertisement delivery platform determines a targeting condition matching the historical advertisement among the targeting conditions according to the acquired information about the delivery click-through situations. Specific methods may be as follows:

### Method 1

When there is one historical advertisement, the information about the delivery click-through situations may only include a click-through rate, that is, in step 101, the advertisement delivery platform acquires click-through rates, of a historical advertisement having a type the same as a type of a to-be-delivered advertisement, in targeting conditions. Certainly, the information about the delivery click-through situations may also be a click-through amount and a delivery amount, and a corresponding click-through rate may be calculated.

In this case, the advertisement delivery platform may determine, according to the click-through rates of the historical advertisement in the targeting conditions, a targeting condition having a corresponding click-through rate greater than a preset threshold as a targeting condition matching the historical advertisement.

For example, a click-through rate of a historical advertisement among a user group aged from 18 to 23 is 20%, a click-through rate among a user group aged from 24 to 30 is 18%, a click-through rate among a user group aged from 30 to 40 is 14%, and a preset threshold is 16%, and therefore, targeting conditions matching the advertisement are: age of 18 to 23 and age of 24 to 30.

Preferably, the preset threshold may be a sum of a total click-through rate of the advertisement delivery platform and a preset percentage value (for example, 2%). Under the premise that some errors are acceptable, this manner of setting the threshold can guarantee that a click-through rate of the to-be-delivered advertisement is not less than a total click-through rate of an entire platform and can maintain the total click-through rate of the entire advertisement delivery platform.

### Method 2

When there are more than one historical advertisements, the information about the delivery click-through situations may include delivery amounts and click-through amounts. Besides, the information about the delivery click-through situations may also be either of the delivery amount and the click-through amount, and a click-through rate.

In this case, first, the advertisement delivery platform determines, for each targeting condition, an average click-through rate of historical advertisements in the targeting condition according to delivery amounts and click-through amounts of the historical advertisements in the targeting condition; then, the advertisement delivery platform determines a targeting condition having a corresponding average click-through rate greater than a preset threshold as a targeting condition matching the historical advertisements.

The delivery amounts and click-through amounts of the historical advertisements in the targeting condition may be a delivery amount and a click-through amount of each historical advertisement in the targeting condition, or may also be a total delivery amount and a total click-through rate of the multiple historical advertisements in the targeting condition. In the former case, the average click-through rate in the targeting condition is obtained by dividing a sum of click-through amounts of the historical advertisements in the targeting condition by a sum of delivery amounts of the historical advertisements in the targeting condition. In the latter case, the average click-through rate in the targeting condition is obtained by dividing a total click-through amount by a total delivery amount.

For example, the historical advertisements include historical advertisement 1 and historical advertisement 2. A delivery amount and a click-through amount of historical advertisement 1 among a user group aged from 18 to 23 are 100,000 and 20,000 respectively, a delivery amount and a click-through amount among a user group aged from 24 to 30 are 80,000 and 16,000 respectively, and a delivery amount and a click-through amount among a user group aged from 30 to 40 are 50,000 and 4,000 respectively; a delivery amount and a click-through amount of historical advertisement 2 among a user group aged from 18 to 23 are 100,000 and 25,000 respectively, a delivery amount and a click-through amount among a user group aged from 24 to 30 are 80,000 and 24,000 respectively, and a delivery amount and a click-through amount among a user group aged from 30 to 40 are 50,000 and 6,000 respectively; and the preset threshold is 16%. In this case, an average click-through rate of the historical advertisements among the user group aged from 18 to 23 is 22.5%, an average click-through rate of the historical advertisements among the user group aged from 24 to 30 is 25%, and an average click-through rate of the historical advertisements among the user group aged from 30 to 40 is 10%. Therefore, targeting conditions matching the historical advertisements are: age of 18 to 23 and age of 24 to 30.

Preferably, the preset threshold may be a sum of a total click-through rate of the advertisement delivery platform and a preset percentage value n % (for example, 2%). Under the premise that some errors are acceptable, this manner of setting the threshold can guarantee that a click-through rate of the to-be-delivered advertisement is not less than a total click-through rate of an entire platform and can maintain the total click-through rate of the entire advertisement delivery platform.

Step 103: The advertisement delivery platform presents the determined targeting condition. In the foregoing processing procedure, a targeting condition matching a historical advertisement is determined, and the targeting condition is used as a targeting condition matching a to-be-delivered advertisement, and is recommended and presented to an advertiser of the to-be-delivered advertisement.

Specifically, the advertisement delivery platform may send the determined targeting condition to a terminal of the advertiser of the to-be-delivered advertisement and display the targeting condition on the terminal.

Preferably, during presentation, the determined targeting condition may be presented in correspondence to the click-through rate or average click-through rate of the historical advertisement in the targeting condition. In this way, the advertiser may view click-through rates corresponding to different targeting conditions more intuitively.

Further, the to-be-delivered advertisement is delivered according to the determined targeting condition. Specifically, when the method is applied in a delivery process of a new advertisement, the new advertisement is delivered according to the determined targeting condition; when the method is applied in a redelivery process of an advertisement that has already been delivered, the advertisement is delivered again according to the determined targeting condition. Certainly, besides that delivery is performed according to the determined targeting condition, a revision suggestion that matches the determined targeting condition may be given to the advertiser according to the determined targeting condition, to help the advertiser to precisely target a core targeted population. The presentation platform may maintain a correspondence between the revision suggestion and the targeting condition.

In this embodiment of the present invention, according to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

### Embodiment 3

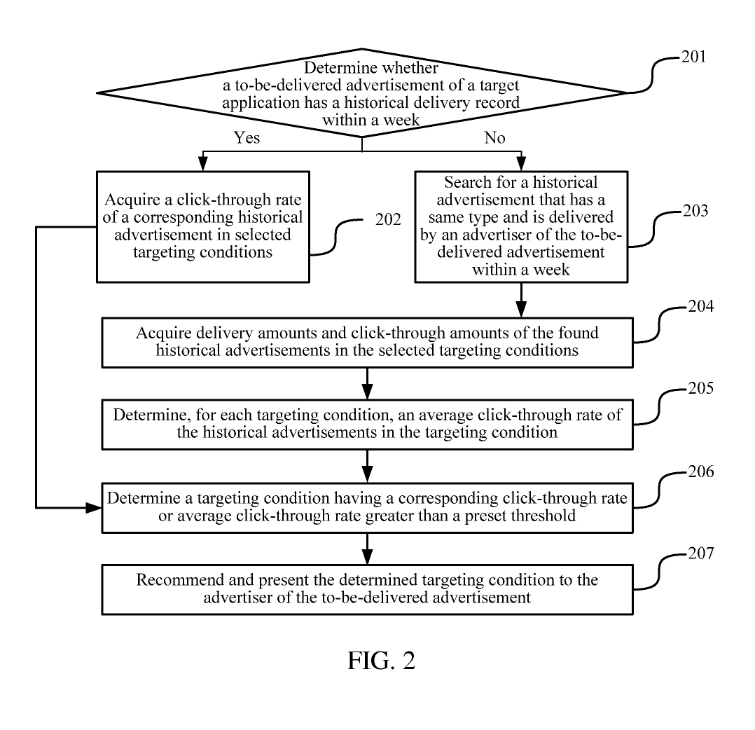

The following further describes, with reference to a specific application scenario, the method for presenting a targeting condition of a network advertisement provided in this embodiment of the present invention. In this application scenario, a developer of a social network application advertises the social network application, and therefore, the developer is an advertiser of the advertisement. Referring to FIG. 2, a specific process may include the following steps:

Step 201: Determine whether a to-be-delivered advertisement of a target application has a historical delivery record within a week, and if yes, perform step 202, and otherwise, perform step 203.

Step 202: Acquire a click-through rate of a corresponding historical advertisement (it is assumed that there is one historical delivery within the week) in selected targeting conditions; perform steps 206 and 207 after this step.

Step 203: Search for a historical advertisement (it is assumed that the historical advertisement can be found) that has a same type and is delivered by an advertiser of the to-be-delivered advertisement within a week.

Step 204: Acquire delivery amounts and click-through amounts of the found historical advertisements (it is assumed that multiple historical advertisements having the same type are found) in the selected targeting conditions.

Step 205: Determine, for each targeting condition, an average click-through rate of the historical advertisements in the targeting condition. For details, reference may be made to method 2 in step 102 of Embodiment 2.

Step 206: Determine a targeting condition having a corresponding click-through rate or average click-through rate greater than a preset threshold.

Step 207: Recommend and present the determined targeting condition to the advertiser of the to-be-delivered advertisement.

In this embodiment of the present invention, according to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

### Embodiment 4

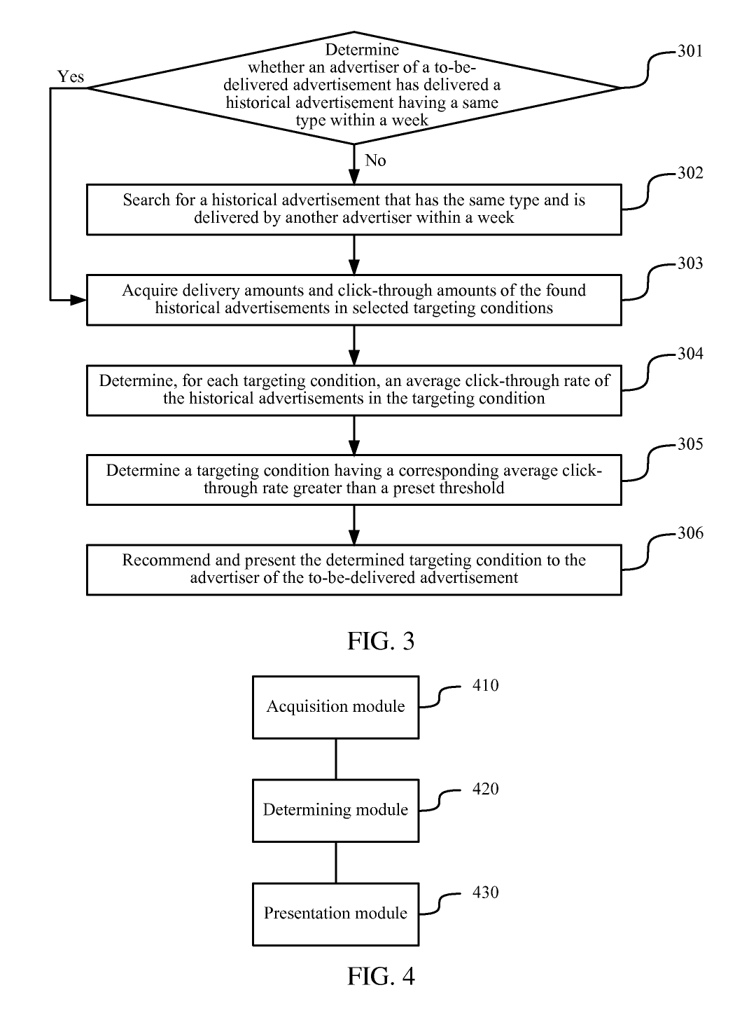

The following further describes, with reference to a specific application scenario, the method for presenting a targeting condition of a network advertisement provided in this embodiment of the present invention. In this application scenario, an advertiser delivers an external-link advertisement in a social network platform, and the external-link advertisement is a newly delivered advertisement. Referring to FIG. 3, a specific process may include the following steps:

Step 301: Determine whether an advertiser of a to-be-delivered advertisement has delivered a historical advertisement having a same type within a week, and if not, perform step 302, or if yes, directly perform step 303.

Step 302: Search for a historical advertisement (it is assumed that the historical advertisement can be found) that has the same type and is delivered by another advertiser within a week, and perform step 303.

Step 303: Acquire delivery amounts and click-through amounts of the found historical advertisements (it is assumed that multiple historical advertisements having the same type are found) in selected targeting conditions.

Step 304: Determine, for each targeting condition, an average click-through rate of the historical advertisements in the targeting condition. For details, reference may be made to method 2 in step 102 of Embodiment 2.

Step 305: Determine a targeting condition having a corresponding average click-through rate greater than a preset threshold.

Step 306: Recommend and present the determined targeting condition to the advertiser of the to-be-delivered advertisement.

In this embodiment of the present invention, according to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

### Embodiment 5

Based on a same technical concept, this embodiment of the present invention further provides an apparatus for presenting a targeting condition of a network advertisement. Referring to FIG. 4, the apparatus includes:

an acquisition module 410, configured to acquire information about delivery click-through situations, of a historical advertisement having a type the same as a type of a to-be-delivered advertisement, in targeting conditions;

a determining module 420, configured to determine a targeting condition matching the historical advertisement among the targeting conditions according to the acquired information about the delivery click-through situations; and

a presentation module 430, configured to present the determined targeting condition.

Preferably, the acquisition module 410 is specifically configured to:

search for a historical advertisement that has a type and an advertisement deliverer the same as the type and an advertisement deliverer of a to-be-delivered advertisement and is delivered in a preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and

acquire information about click-through situations of the found historical advertisement in targeting conditions.

Preferably, if the to-be-delivered advertisement is not a newly delivered advertisement, the acquisition module 410 is specifically configured to:

search for a historical advertisement in previous delivery of the to-be-delivered advertisement delivered in a preset time period; search for, if the historical advertisement is not found, a historical advertisement that has a type and an advertisement deliverer the same as the type and an advertisement deliverer of the to-be-delivered advertisement and is delivered in the preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and

acquire information about click-through situations of the found historical advertisement in targeting conditions.

Preferably, there is one historical advertisement and the information about the delivery click-through situations includes click-through rates; and

the determining module 420 is specifically configured to:

determine, according to the click-through rates of the historical advertisement in the targeting conditions, a targeting condition having a corresponding click-through rate greater than a preset threshold as a targeting condition matching the historical advertisement.

Preferably, there are more than one historical advertisements, and the information about the delivery click-through situations includes delivery amounts and click-through amounts; and

the determining module 420 is specifically configured to:

determine, for each targeting condition, an average click-through rate of the historical advertisements in the targeting condition according to delivery amounts and click-through amounts of the historical advertisements in the targeting condition; and

determine a targeting condition having a corresponding average click-through rate greater than a preset threshold as a targeting condition matching the historical advertisements.

Preferably, the preset threshold is a sum of a total click-through rate of an advertisement delivery platform and a preset percentage value.

Preferably, the presentation module 430 is specifically configured to:

present the determined targeting condition in correspondence to the click-through rate or average click-through rate of the historical advertisement in the targeting condition.

Preferably, the apparatus further includes a delivery module, where

the delivery module is configured to deliver the to-be-delivered advertisement according to the determined targeting condition. In this embodiment of the present invention, according to delivery click-through situations, of a historical advertisement having a type the same as a type of a to-be-delivered advertisement, in targeting conditions, a targeting condition matching the historical advertisement is determined, and is presented as a recommended targeting condition of the to-be-delivered advertisement. Therefore, when a new advertisement is to be delivered, a targeting condition having a relatively high matching degree may be provided for an advertisement deliverer, which can improve the utilization rate of system and network resources in a network advertisement delivery process.

It should be noted that the above functional modules are only described for exemplary purposes when the apparatus for presenting a targeting condition of a network advertisement provided by the foregoing embodiments presents a targeting condition. In actual applications, the functions may be allocated to different functional modules according to specific needs, which means that the internal structure of the apparatus is divided into different functional modules to complete all or some of the above described functions. In addition, the apparatus for presenting a targeting condition of a network advertisement provided by the foregoing embodiments and the method for presenting a targeting condition of a network advertisement in the foregoing embodiments belong to the same concept. For the specific implementation process, refer to the method embodiments, and details are not described herein again.

The sequence numbers of the foregoing embodiments of the present invention are merely for the convenience of description, and do not imply the preference among the embodiments.

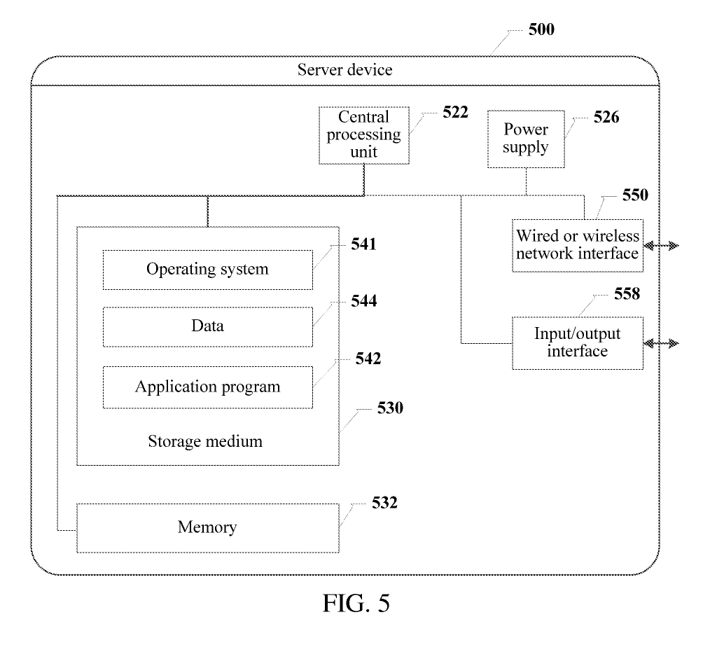

A person of ordinary skill in the art may understand that all or a part of steps of the foregoing embodiments may be implemented by the following hardware. FIG. 5 is a schematic structural diagram of a server in an embodiment of the present invention. The server 500 may vary significantly due to different configurations or performance, and may include one or more central processing units (CPUs) 522 (for example, one or more processors), a memory 532, and one or more storage media 530 (for example, one or more mass storage devices) for storing an application program 542 or data 544. The memory 532 and the storage medium 530 may be transitory or permanent storage. The program stored in the storage medium 530 may include one or more modules (not shown in the figure), and each module may include a series of instructional operations on the server. Further, the CPU 522 may be configured to communicate with the storage medium 530, and perform, on the server 600, a series of instructional operations in the storage medium 530.

The server 500 may further include one or more power supplies 526, one or more wired or wireless network interfaces 550, one or more input/output interfaces 558, and/or one or more operating systems 541, such as Windows Server™, Mac OS X™, Unix™, Linux™, and FreeBSD™.

In addition, it should be clear that the storage medium 530 described herein (for example, a memory) may be a volatile memory or a non-volatile memory, or may include both a volatile memory and a non-volatile memory. As a nonrestrictive example, the non-volatile memory may include a read-only memory (ROM), a programmable ROM (PROM), an electrically programmable ROM (EPROM)), an electrically erasable programmable ROM (EEPROM), or a flash memory. The volatile memory may include a random access memory (RAM). The RAM may function as a cache memory. As a nonrestrictive example, the RAM may be obtained in multiple forms, for example, a synchronous RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct Rambus RAM (DRRAM). The disclosed storage device includes, but is not limited to the foregoing memories and other proper memories.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for presenting a targeting condition of a network advertisement, comprising:
acquiring information about delivery click-through situations, of a historical advertisement having a type the same as a type of a to-be-delivered advertisement, in targeting conditions;
determining a targeting condition matching the historical advertisement among the targeting conditions according to the acquired information about the delivery click-through situations; and
presenting the determined targeting condition
wherein the acquiring information about delivery click-through situations, of a historical advertisement having a type the same as a type of a to-be-delivered advertisement, in targeting conditions comprises:
searching for a historical advertisement that has a type and an advertisement deliverer the same as the type and an advertisement deliverer of a to-be-delivered advertisement and is delivered in a preset time period; and searching for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and
acquiring information about click-through situations of the found historical advertisement in targeting conditions.

2. (canceled)

3. The method according to claim 1, wherein the to-be-delivered advertisement is not a newly delivered advertisement, the method further comprises:
searching for a historical advertisement in previous delivery of the to-be-delivered advertisement delivered in a preset time period; and
if the historical advertisement is not found, the searching for a historical advertisement that has a type and an advertisement deliverer the same as the type and an advertisement deliverer of the to-be-delivered advertisement and is delivered in the preset time period; and searching for, if the historical advertisement is not found, a historical advertisement that has a type the same as a type of the to-be-delivered advertisement but has an advertisement deliverer different from the advertisement deliverer of the to-be-delivered advertisement and is delivered in the preset time period is performed.

4. The method according to claim 1, wherein there is one historical advertisement and the information about the delivery click-through situations comprises click-through rates; and
the determining a targeting condition matching the historical advertisement among the targeting conditions according to the acquired information about the delivery click-through situations is specifically:
determining, according to the click-through rates of the historical advertisement in the targeting conditions, a targeting condition having a corresponding click-through rate greater than a preset threshold as the targeting condition matching the historical advertisement.

5. The method according to claim 1, wherein there are more than one historical advertisements, and the information about the delivery click-through situations comprises delivery amounts and click-through amounts; and
the determining a targeting condition matching the historical advertisement among the targeting conditions according to the acquired information about the delivery click-through situations is specifically:
determining, for each targeting condition according to a delivery amount and a click-through amount of the historical advertisement in the targeting condition, an average click-through rate of the historical advertisements in the targeting condition according to delivery amounts and click-through amounts of the historical advertisements in the targeting condition; and
determining a targeting condition having a corresponding average click-through rate greater than a preset threshold as the targeting condition matching the historical advertisements.

6. The method according to claim 4, wherein the preset threshold is a sum of a total click-through rate of an advertisement delivery platform and a preset percentage value.

7. The method according to claim 1, wherein the presenting the determined targeting condition is specifically:
presenting the determined targeting condition in correspondence to the click-through rate or average click-through rate of the historical advertisement in the targeting condition.

8. The method according to claim 1, wherein the method further comprises:
delivering the to-be-delivered advertisement according to the determined targeting condition.

9. An apparatus for presenting a targeting condition of a network advertisement, comprising:
memory;
one or more processors; and
one or more programs stored in the memory and configured for execution by the one or more processors, the one or more programs comprising the following instruction modules:
an acquisition module, configured to acquire information about delivery click-through situations, of a historical advertisement having a type the same as a type of a to-be-delivered advertisement, in targeting conditions;
a determining module, configured to determine a targeting condition matching the historical advertisement among the targeting conditions according to the acquired information about the delivery click-through situations; and
a presentation module, configured to present the determined targeting condition
wherein the acquisition module is specifically configured to:
search for a historical advertisement that has a type and an advertisement deliverer the same as the type and an advertisement deliverer of a to-be-delivered advertisement and is delivered in a preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period; and
acquire information about click-through situations of the found historical advertisement in targeting conditions.

10. (canceled)

11. The apparatus according to claim 9, wherein, the to-be-delivered advertisement is not a newly delivered advertisement, the acquisition module is further configured to:
search for a historical advertisement in previous delivery of the to-be-delivered advertisement delivered in a preset time period; and
if the historical advertisement is not found, the acquisition module is configured to search for a historical advertisement that has a type and an advertisement deliverer the same as the type and an advertisement deliverer of the to-be-delivered advertisement and is delivered in the preset time period; and search for, if the historical advertisement is not found, a historical advertisement that has a type the same as a type of the to-be-delivered advertisement but has an advertisement deliverer different from the advertisement deliverer of the to-be-delivered advertisement and is delivered in the preset time period.

12. The apparatus according to claim 9, wherein there is one historical advertisement and the information about the delivery click-through situations comprises click-through rates; and
the determining module is specifically configured to:
determine, according to the click-through rates of the historical advertisement in the targeting conditions, a targeting condition having a corresponding click-through rate greater than a preset threshold as a targeting condition matching the historical advertisement.

13. The apparatus according to claim 9, wherein there are more than one historical advertisement, and the information about the delivery click-through situations comprises delivery amounts and click-through amounts; and
the determining module is specifically configured to:
determine, for each targeting condition, an average click-through rate of the historical advertisements in the targeting condition according to delivery amounts and click-through amounts of the historical advertisements in the targeting condition; and
determine a targeting condition having a corresponding average click-through rate greater than a preset threshold as a targeting condition matching the historical advertisements.

14. The apparatus according to claim 12, wherein the preset threshold is a sum of a total click-through rate of an advertisement delivery platform and a preset percentage value.

15. The apparatus according to claim 9, wherein the presentation module is specifically configured to:
present the determined targeting condition in correspondence to the click-through rate or average click-through rate of the historical advertisement in the targeting condition.

16. The apparatus according to claim 9, wherein the apparatus further comprises:
a delivery module, configured to deliver the to-be-delivered advertisement according to the determined targeting condition.
